(19) United States
(12) Patent Application Publication
(10) Pub. No.: US 2010/0176218 A1
(43) Pub. Date: Jul. 15, 2010

(54) Apparatus for delivery of lawn treatment products through a lawn irrigation system and for maintenance of said system

(76) Inventor: Mark C. Carpenter, Zephyrhills, FL (US)

Correspondence Address: SIDNEY WALLIS KILGORE, PENNINGTON, MOORE, WILKINSON, BELL & DUNBAR, PA, 2701 NORTH ROCKY POINT DRIVE- SUITE 900, TAMPA, FL, 33607-5975, US

(21) Appl. No.: 12/319,974

(22) Filed: Jan. 14, 2009

(51) Int. Cl. A62C 5/02

(52) U.S. Cl. 239/310

(57) ABSTRACT

This invention comprises a new and improved apparatus for distributing automatically lawn treatment products, including chemical nutrients, herbicides, fungicides, and insecticides, through a lawn irrigation system using either potable or reclaimed water, and for maintaining the system in good working order. An adjustable multi-outlet watering manifold allows a user to regulate the amount of product to be applied to the particular zone serviced by each sprinkler station.

Sediment and contaminants that may be found in the main water source are filtered out before reaching the lawn irrigation system, and the design of the apparatus makes regular flushing of the main water line easy. A liquid pressure gauge allows a user to discern immediately whether an observed drop in water pressure is due to a break or other problem with the main water supply. The configuration of the apparatus provides redundant means of preventing contamination the main water source via backflow.

### CROSS-REFERENCES TO RELATED APPLICATIONS

Not applicable.

### STATEMENT REGARDING FEDERALLY SPONSORED RESEARCH OR DEVELOPMENT

Not applicable.

### MICROFICHE APPENDIX

Not applicable.

### BACKGROUND OF THE INVENTION

1. Field of the Invention

This invention relates to the field of devices for the distribution of various lawn treatment products, including chemical nutrients, herbicides, fungicides and insecticides, through irrigation systems, and for irrigation system maintenance.

2. Description of Related Art

Dry lawns become weak lawns that are substantially more vulnerable to attack from insects, fungus, and weeds and require more intensive regular maintenance through the application of chemical treatments and fertilizers. Persistent drought conditions are becoming increasingly more common in many geographical locations, rendering lawns composed of certain types of “thirsty” grasses, often the most popular varieties in drought-prone areas, much more difficult and expensive to keep healthy as ever-greater water rationing is imposed on outdoor sprinkler use and traditional third-party lawn maintenance services, which apply lawn treatment chemicals and fertilizers, become more dear.

The stress on lawns due to long-term drought conditions can be exacerbated by a loss of water pressure in lawn irrigation lines, which is a common occurrence and often goes unnoticed by property owners until their lawns have incurred significant damage. Such loss of water pressure can accompany a break in a water line within the irrigation system for the lawn itself or can be due to a general loss of water pressure from a break or other cause in the municipal main or other water supply to the property.

Broken lines, whether local or not, can allow foreign debris into the line, causing sprinkler heads to clog and compounding the problem of getting adequate irrigation to a lawn. If a break occurs somewhere in the sprinkler system providing irrigation to a lawn, a large quantity of water may be lost if the break is not timely discovered and addressed, costing the property owner substantial sums of money.

As a means of addressing the ever-growing demand for water, many conservation-minded communities are making reclaimed water available for irrigation of public, commercial, and residential. Reclaimed water itself, however, can naturally contain gross particulate matter that can lead to clogged sprinkler heads, and in turn, cause lawns to dry out and die.

Fertilizers, herbicides, fungicides, and insecticides are typically water-soluble and ordinarily may be applied to a lawn by their addition into a water base for distribution using either hand-held irrigation devices or fixed irrigation systems. Automated systems for distributing lawn treatment products through sprinkler systems, either alone or in combination are not unknown.

Existing automated sprinkler distribution systems, however, can be relatively complex, expensive, and often require trained service personnel to operate properly, increasing lawn maintenance costs to the property owner. In addition, while these systems generally may work quite well with potable water sources, they are not specifically designed to prevent the kinds of sprinkler system maintenance problems that arise from sedimentation when reclaimed water is used for lawn irrigation, or when breaks occur in a water line.

These known systems ordinarily fail to filter out adequately sedimentation and contaminants from the water lines before they can reach and clog sprinkler heads, and they fail to include easy means for flushing the water lines to eliminate such sedimentation and contaminants. Furthermore, they provide no simple way for a user to monitor the pressure of water lines and determine if a loss in pressure has occurred and whether that loss of pressure is due to a break within the sprinkler system itself or in the water main supply to the sprinkler system.

### BRIEF SUMMARY OF THE INVENTION

The present invention comprises a new and improved apparatus for distributing automatically lawn care products, including chemical nutrients, herbicides, fungicides, and insecticides, through an ordinary lawn sprinkler system using either potable or reclaimed water, and for maintaining the sprinkler system in good working order.

### BRIEF DESCRIPTION OF THE SEVERAL VIEWS OF THE DRAWINGS

FIG. 1 is an overhead perspective of one appropriate configuration of the apparatus.

FIG. 2 is a close-up exploded view reflecting the removal of the filter housing for the filter to enable cleaning and replacement of the filter.

FIG. 3 is a cutaway view of the container for the lawn treatment products.

FIG. 4 is a close-up view reflecting the connection of individual drip line hoses to each station of the sprinkler system.

### REFERENCE NUMERALS IN THE DRAWINGS

101 Main water supply line

102 PVC 1-inch slip by slip elbow

103 First 3-inch long PCV pipe of 1-inch diameter

104 Back-flow valve (one-way dual check valve)

105 Second 3-inch long PCV pipe of 1-inch diameter

106 Main PVC on-off ball valve

107 Third 3-inch long PCV pipe of 1-inch diameter

108 Second PVC 1-inch slip by slip elbow

109 Fourth 3-inch long PCV pipe of 1-inch diameter

110 PVC female ‘T’ coupling

111 ½-inch diameter by ¾-inch long threaded nipple

112 Liquid pressure gauge

113 Filter assembly

114 Detachable transparent filter housing

115 Main water line filter

116 Detachable two-ended ball check valve

117 Bushing

118 Sixth 3-inch long PVC pipe of 1-inch diameter

119 Third PVC 1-inch slip by slip elbow

120 27-inch long PVC pipe of 1-inch diameter

121 Fourth PVC 1-inch slip by slip elbow

122 Pipe

123 Connective fitting

124 Solenoid valve

125 Outlet water line

126 Sprinkler head

127 Container

128 Lid or cover

129 Marks for measuring content of container

130 Mutli-outlet adjustable watering manifold

131 Drip line hose

132 Intermediate connector

133 2-inch long high-pressure hose

134 1-inch diameter slip-slip ‘T’ connector

301 Single reinforced flex hose

302 Inlet line connector

303 Container Filter

### DETAILED DESCRIPTION OF THE INVENTION

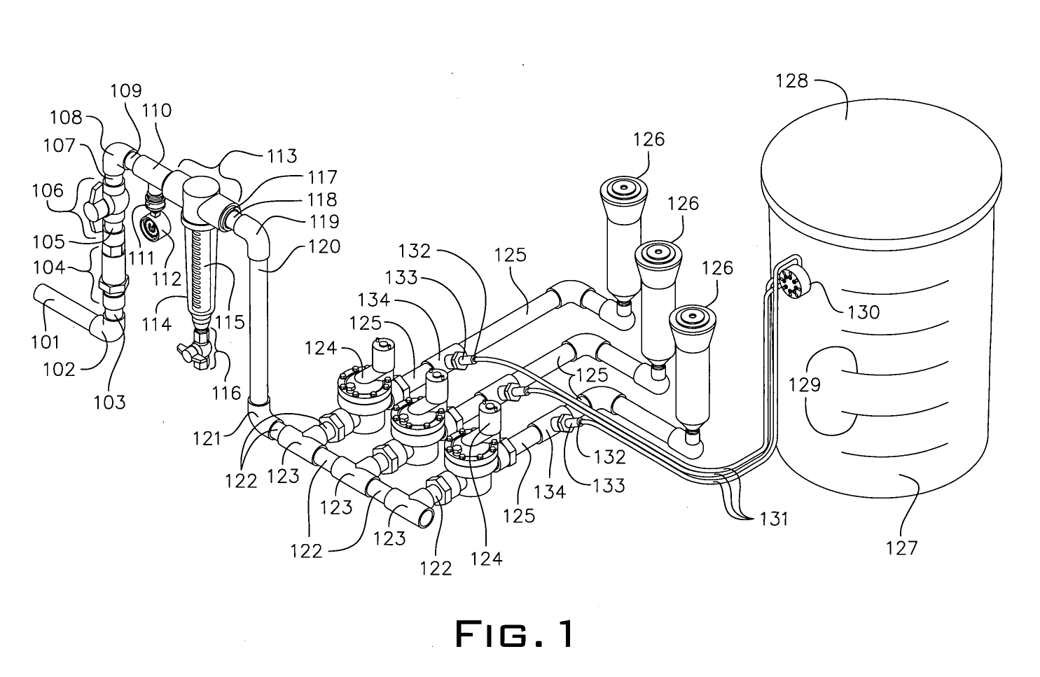

An overhead perspective of one embodiment of the apparatus is reflected in FIG. 1. Except as may be indicated otherwise, the interconnections illustrated in this embodiment utilize Schedule 20 PVC pipes and connectors of specified dimensions, though other pipes and fittings of various sizes, including those made of lead, brass, and other materials, may be used. When PVC pipes are used, they may be purple in color to reflect the use of reclaimed water.

FIG. 1 shows a main water supply line 101 connected via a PVC 1-inch slip by slip (slip-slip) elbow 102 and an adjoining 3-inch long PCV pipe of 1-inch diameter 103 to a back-flow valve 104, which may be a one-way dual check valve, to prevent chemically treated water from returning from the apparatus and the sprinkler (lawn irrigation) system to the main water supply line 101 and potentially contaminating the main water source, whether it be potable or reclaimed water. The back-flow valve 104 is, in turn, connected by way of a second 3-inch long PCV pipe of 1-inch diameter 105 to a main PVC on-off ball valve 106, which controls the entry of water to the apparatus and sprinkler system. The main PVC on-off ball valve 106 provides a means for easily shutting off the water supply for maintenance of the apparatus and sprinkler system.

FIG. 1 further reflects that the main PVC on-off ball valve 106 is connected by means of a third 3-inch long PCV pipe of 1-inch diameter 107, a second PVC 1-inch slip by slip elbow 108, and a fourth 3-inch long PCV pipe of 1-inch diameter 109 to the first of two 1-inch diameter horizontal orifices of a PVC female ‘T’ coupling with a third “bottom” orifice (perpendicular to the two horizontal orifices) of ½-inch diameter 110. A ½-inch diameter by ¾-inch long threaded nipple 111 is attached to bottom orifice of the PVC female ‘T’ coupling 110, and in turn, a liquid pressure gauge 112, which may be a 200-lb. P.S.I. liquid pressure gauge, is attached to the nipple 111.

When the main PVC on-off ball valve 106 is in the fully open position, the water pressure arriving to the system from the main water line 101 can be easily checked to determine whether any observable loss of water pressure in the sprinkler system is due to a break or other problem within the sprinkler system, or otherwise due to a break or other problem external to the sprinkler system, e.g., a break in a water main providing water to the apparatus and sprinkler system. The baseline normal pressure for a given system will vary according to the supply source and other factors. If pressure is being lost before water arrives to the apparatus and sprinkler system, the pressure gauge 112 will indicate, relative to any such baseline normal pressure, an abnormally low pressure, or will indicate a steady loss of pressure or sporadic changes in pressure. If the pressure gauge 112 reflects that the baseline normal pressure for the system is being maintained, a user may conclude that there is likely a break in, or some other problem with, the sprinkler system itself that is causing the loss in pressure, and can then undertake to locate the source of the break or other problem and effectuate such repairs as may be necessary or appropriate.

The second 1-inch diameter end of the PVC female ‘T’ coupling 110 is attached by means of a fifth 3-inch long PVC pipe of 1-inch diameter (not visible in FIG. 1) and an adjoining bushing of 1-inch diameter on one end and 1½ inches on the other (also not visible in FIG. 1) to the first of two 1½-inch diameter threaded orifices of a filter assembly 113. A detachable transparent filter housing 114, which may be threadably detachable, allows a user to monitor visibly the condition of an enclosed main water line filter 115 and to access the same for periodic cleaning or replacement, while a detachable two-ended ball check valve 116, which may be threadably detachable, one end of which is attached to the bottom of the filter housing 114 and the other end of which remains open and unattached, allows a user to flush the main water line filter 115 and the water lines of the apparatus and sprinkler system easily.

After passing through the main water line filter 115, water originating from the main water supply line 101 proceeds through a series of pipes and connectors 117-123 to the outlet port(s) of one or more solenoid valves 124 for one or more sprinkler stations for the lawn irrigation system. The placement of the main water line filter 115 in advance of the one or more solenoid valves 124, each such valve associated with a given station of the sprinkler system, reduces the opportunity for sedimentation and contaminants found in reclaimed water, or in water from a source in which a break in the line or other problem has occurred, from reaching the solenoid valves 124 or the sprinkler heads 126 associated with a given sprinkler station.

A second bushing 117 of 1-inch diameter on one end and 1½ inches on the other is joined from the second 1½-inch orifice of the filter assembly 113 to a sixth 3-inch long PVC pipe of 1-inch diameter 118, which in turn is attached to a third PVC 1-inch slip by slip elbow 119 that is joined to a 27-inch long PVC pipe of 1-inch diameter 120 to which a fourth PVC 1-inch slip by slip elbow 121. The latter is then attached by means of additional pipes 122 and connective fittings 123 to the water inlet port of each of one or more solenoid valves 124 of the one or more sprinkler stations, with the outlet port of each solenoid valve 124 leading by way of an outlet water line 125 to one or more sprinkler heads 126 or similar terminal outlets for distribution of water from an irrigation system to a lawn.

A container 127, which may have a cover or lid 128, serves as a dispensing repository for lawn treatment products to be applied to a lawn, and may also be used to mix those products in an aqueous solution. The lawn treatment products that may be introduced into a container 127 may include, without limitation, chemical nutrients, herbicides, fungicides, and insecticides, which ordinarily will be water-soluble. One or more pathways, which may be comprised of pipes, hoses, and various forms of connectors, are interposed between the container 127 and a sprinkler system or an individual station thereof. Each such pathway serves to transport liquid comprising or consisting of lawn treatment products from the container 127 into a water stream flowing through the sprinkler system and onto a lawn by means of hydrostatic pressure generated by that water stream. As such, the open end of each pathway terminating at the container, or of any common pathway carrying lawn treatment products from inside the container to multiple pathways terminating at the container, ideally will be submerged in or otherwise positioned below the surface of the liquid comprising or consisting of lawn treatment products in the container 127.

Multiple containers may be incorporated into the apparatus. The capacity of a given container 127 may vary, though five gallons is a particularly useful size for household use. Higher-capacity containers, e.g., of 75 gallons each, may be required for large residential or commercial lawn irrigation systems, especially where only a single container is used.

A typical container 127 may be composed of any number of materials. The use of transparent or translucent plastic, however, allows a user to readily ascertain the volume of the liquid containing the lawn treatment products within the container 127 without removing its lid 128. To this end, volume marks 129 to indicate the volume of liquid inside the container 127 may be added to the outside of the container as well as to the inside.

As illustrated in the embodiment depicted in FIG. 1, a multi-outlet adjustable watering manifold 130, such as the Rain Drip Hydroport, may be inserted through the side of the container 127 to facilitate the use of multiple drip line hoses 131 for carrying lawn treatment product from the container 127 to multiple sprinkler stations and to allow variations in the volume of product to be applied to the zone of the lawn serviced by a particular sprinkler station. More than one watering manifold 130 may be used per container. Each of the drip line hoses 131, which in the embodiment illustrated in FIG. 1 are of ½-inch in diameter, is connected at one end to an outlet port of the watering manifold 130, and at the other end, to the water line 125 between a solenoid valve 124 for a given sprinkler station and the one or more sprinkler heads 126 for that station.

As illustrated in the embodiment in FIG. 1, these connections to the water line 125 may be made by attaching each of the drip line hoses 131 to an intermediate connector 132, which may be a ½-inch diameter female connector reduced to a ¼-inch ribbed male nipple, and then joining the ribbed male nipple of the intermediate connector 132 to a ¼-inch diameter, 2-inch long high-pressure hose 133, which may be attached, in turn, to a ¼-inch diameter threaded orifice embedded in a 1-inch diameter slip-slip ‘T’ connector 134 inserted in the water line 125 between a solenoid valve 124 and the one or more sprinkler heads 126 of the sprinkler station. The use of short sections of high-pressure hose 133 to make these connections prevents kinks that could inhibit the consistent delivery of lawn care treatment products into the sprinkler system. Moreover, by introducing the lawn treatment products at a location in the water line 125 between a solenoid valve 124 and a sprinkler head 126, the solenoid valve 124 can then serve as a redundant check valve to further inhibit backflow of chemicals from the apparatus and sprinkler system to the main water source.

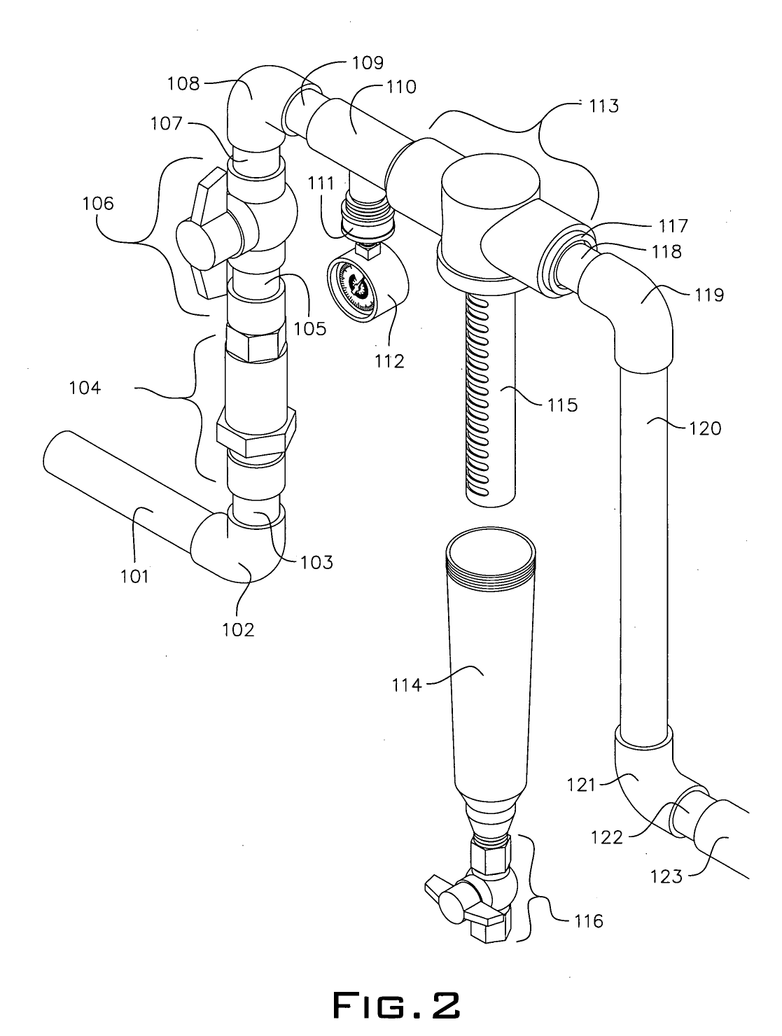

FIG. 2 presents an exploded view of the detachable transparent filter housing 114 after being detached from the filter assembly 113 to expose the enclosed main water line filter 115 for access for cleaning or removal. The main water line filter 115 may be cleaned, if necessary, in a mild aqueous solution of household bleach. After cleaning or replacement of the main water line filter 115, the filter assembly 113 is re-attached to the filter housing 114.

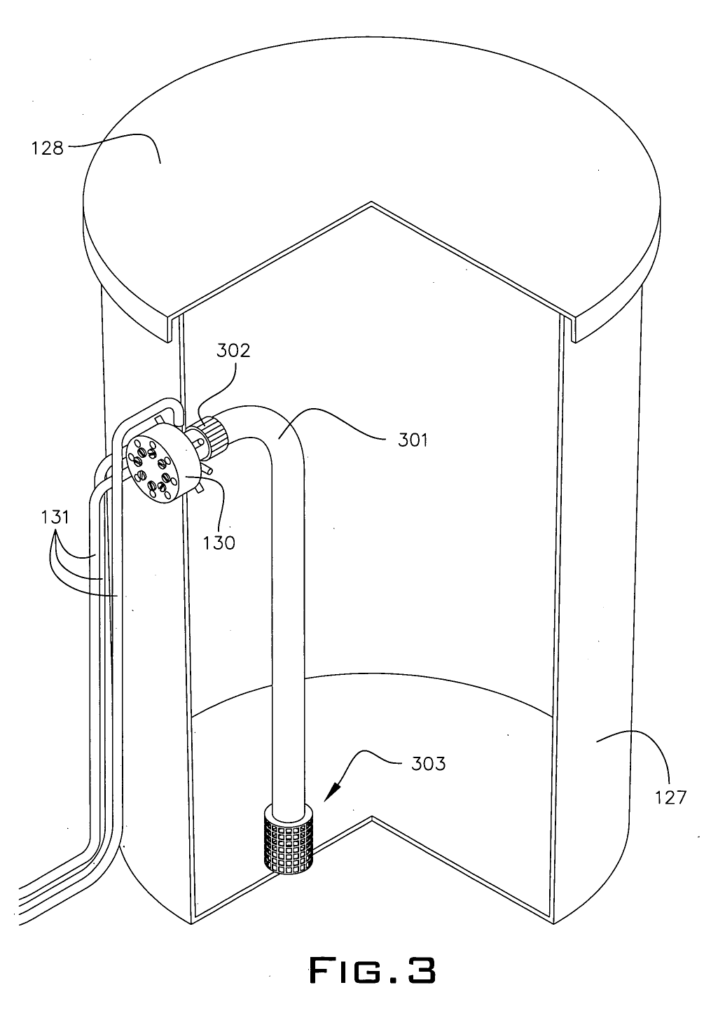

FIG. 3 is a cutaway view of the container 127 and lid 128, revealing the use in the embodiment illustrated of a single reinforced flex hose 301 which acts as a common pathway to carry liquid comprising or consisting of lawn treatment products from inside the container 127 to the watering manifold 128 for ultimate distribution to one or more drip line hoses 131, each of which is attached to an outlet port of the watering manifold 128. The use of the reinforced flex hose 301 can serve to inhibit kinks which could impede the flow of lawn care treatment products from the container 127 to the watering manifold 128.

One end of the flex hose 301 is attached to an inlet line connector 302 of the watering manifold 128. The other end of the flex line 301 is attached to a container filter 303 situated at the bottom of the inside of the container 127. The container filter 303, which is intended to block any sediment or contaminants that may collect in the container 127, could be an ordinary paint filter.

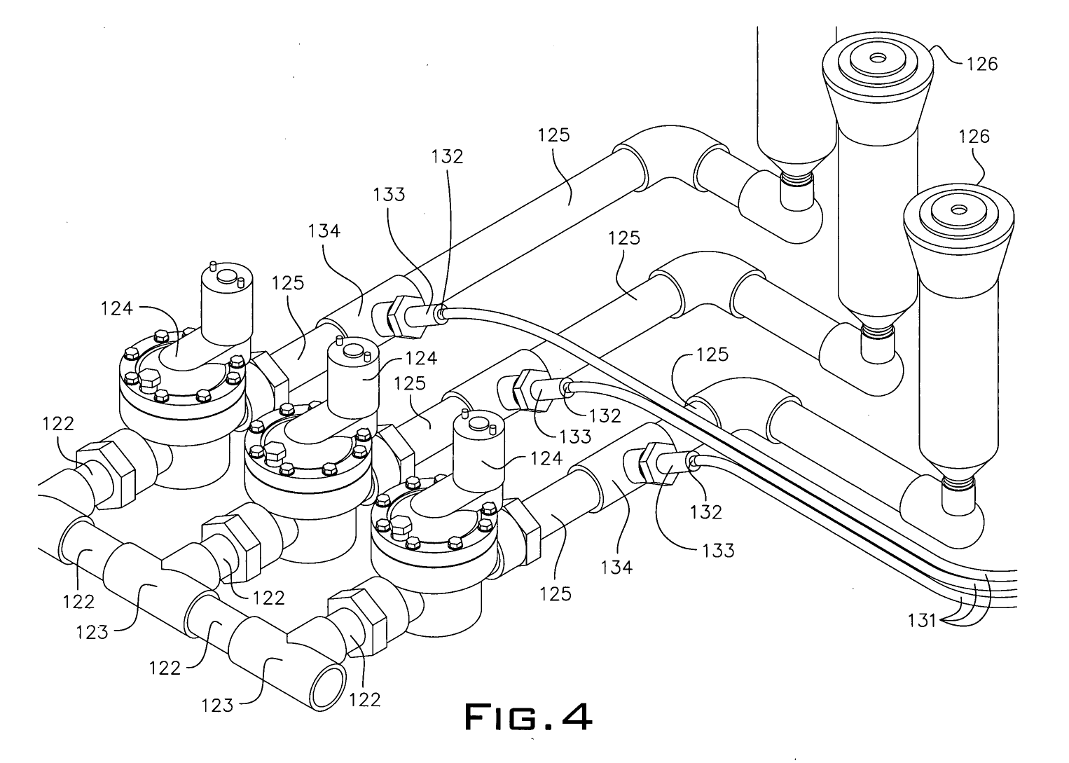

FIG. 4 is a close-up view reflecting the connection of individual drip line hoses 131 to each station of the sprinkler system.

Water-soluble lawn treatment products may be prepared, alone or in combination, either outside of or within the container 127. The amount of a given lawn treatment product or combination of products to be applied to any given station may be regulated by adjusting the valve on the watering manifold 128 governing the particular outlet thereon to which the drip line hose 131 for that station has been attached. Once the prepared lawn treatment product or products are in the container 127 and the sprinkler system is activated, the hydrostatic pressure generated by the sprinkler system will cause the lawn care product(s) to be drawn automatically from the container 127 into and through the designated sprinkler station and distributed via the sprinkler heads to the lawn served by that sprinkler station.

Periodically, the system may be maintained by flushing the lines. The frequency required for flushing will depend, in part, on the extent of sedimentation and contaminants present in the water supply to the sprinkler system. With the sprinkler system off and the main PVC on-off ball valve 106 in the open position, a user may flush the lines by simply opening the normally detachable ball check valve 116 to allow water to flow freely through the unattached end of the detachable ball check valve 116. The user would then close the detachable ball check valve 116 to return the system to normal operability.

The main water line filter 115 should be checked for discoloration and excess sediment buildup on a regular basis. Accumulation of particulate matter on the main water line filter 115 may be removed by detaching the filter housing 114 and rinsing the main water line filter 115 with fresh water. If the main water line filter 115 appears substantially discolored, it may be removed from the filter housing 114, washed in a mild solution of bleach and fresh water and rinsed with fresh water before returning it to the filter housing 114. The main water line filter 115 may be replaced as necessary.

What is claimed is:

1. An apparatus for the delivery of lawn treatment products to a lawn through a lawn irrigation system and for maintenance of said system, comprising:
A back flow valve interposed between a main water supply line for the lawn irrigation system and a main PVC on-off ball valve;
A liquid pressure gauge interposed between said main PVC on-off ball valve and a main water line filter, said main water line filter interposed before one or more solenoid valves serving one or more sprinkler stations of the lawn irrigation system, said main water line filter being accessible by means of a detachable transparent filter housing, to which is attached at the bottom one end of a detachable two-ended ball check valve, the other end of which is open and unattached;
One or more containers for holding, mixing, and distributing lawn treatment products;
One or more pathways interposed between said one or more containers and one or more outlet water lines, each said outlet water line leading from the outlet port of a solenoid valve to one or more sprinkler heads or other terminal outlets of a lawn irrigation system.

2. The apparatus of claim 1, in which the back-flow valve is a one-way dual check valve.

3. The apparatus of claim 1, in which the liquid pressure gauge has a 200 P.S.I. range.

4. The apparatus of claim 1, in which the container has a lid.

5. The apparatus of claim 4, in which the container is made of translucent plastic and has volume marks on the outside.

6. The apparatus of claim 1, in which the one or more pathways are drip line hoses, each of which is attached to an outlet port of a multi-outlet adjustable watering manifold inserted through the side of one of the one or more containers, and in which one end of a reinforced flex hose is attached to an inlet line connector of said watering manifold and the other end of said reinforced flex hose is attached to a container filter situated at the bottom of the inside of the container.

7. The apparatus of claim 6, in which the back-flow valve is a one-way dual check valve.

8. The apparatus of claim 6, in which the liquid pressure gauge has a 200 P.S.I. range.

9. The apparatus of claim 6, in which the container has a lid.

10. The apparatus of claim 9, in which the container is made of translucent plastic and has volume marks on the outside.
